(19) United States
(12) Patent Application Publication
(10) Pub. No.: US 2025/0390341 A1
(43) Pub. Date: Dec. 25, 2025

(54) SCHEDULING METHOD AND COMPUTER SYSTEM

(71) Applicant: CLOUD INTELLIGENCE ASSETS HOLDING (SINGAPORE) PRIVATE LIMITED, SINGAPORE (SG)

(72) Inventor: Kenan LIU, Zhejiang (CN)

(73) Assignee: CLOUD INTELLIGENCE ASSETS HOLDING (SINGAPORE) PRIVATE LIMITED, SINGAPORE (SG)

(21) Appl. No.: 18/843,229

(22) PCT Filed: Feb. 28, 2023
(86) PCT No.: PCT/CN2023/078860

§ 371 Date: Mar. 10, 2025

(30) Foreign Application Priority Data
Mar. 4, 2022 (CN) 202210210979.X

(51) Int. Cl. G06F 9/48

(52) U.S. Cl. CPC G06F 9/4881; G06F 9/4837

(57) ABSTRACT

A scheduling method and a computer system. The scheduling method comprises: according to scheduling priorities respectively corresponding to a plurality of queues which are configured for a physical CPU, sequentially scheduling virtual CPUs in the plurality of queues to run; and when an accumulated running time of the virtual CPU of any virtual machine reaches a set running time of the virtual machine that corresponds to the current scheduling priority, reducing the scheduling priority of the virtual machine, and adding, to the queue corresponding to the current scheduling priority of the virtual machine, at least one virtual CPU which is in the virtual machine and is in a startup state, wherein according to a sequence of the scheduling priorities from high to low, set running times of the virtual machine that correspond to the plurality of scheduling priorities sequentially increase.

This application is a U.S. National Stage Patent Application under 35 U.S.C. § 371 of International PCT Patent Application PCT/CN2023/078860, filed Feb. 28, 2023, and entitled “SCHEDULING METHOD AND COMPUTER SYSTEM”, which claims the priority to Chinese Patent Application No. 202210210979.X filed with the China Patent Office on Mar. 4, 2022 and titled “SCHEDULING METHOD AND COMPUTER SYSTEM”, both of which are incorporated herein by reference in their entireties.

### TECHNICAL FIELD

Embodiments of the present application relate to the field of computer technologies, and in particular, to a scheduling method and a computer system.

### BACKGROUND

In a virtualization scenario, a Central Processing Unit (CPU) allocated to a virtual machine is not a real or physical CPU (Physical Central Processing Unit, referred to as PCPU), but a virtual CPU (Virtual Central Processing Unit, referred to as VCPU). Only when the virtual CPU allocated to the virtual machine is scheduled to run on the physical CPU can tasks be executed. Therefore, this involves scheduling a virtual CPU onto a physical CPU.

### SUMMARY

Embodiments of the present application provide a scheduling method and a computer system.

In a first aspect, an embodiment of the present application provides a scheduling method, including:
sequentially scheduling, according to scheduling priorities respectively corresponding to a plurality of queues configured for a physical CPU, virtual CPUs in the plurality of queues to run;
reducing, in a case where an accumulated virtual CPU running time f any one virtual machine reaches a set running time of the virtual machine corresponding to a current scheduling priority, a scheduling priority of the virtual machine, and adding, to a queue corresponding to the current scheduling priority of the virtual machine, at least one virtual CPU in a startup state in the virtual machine; wherein set running times of the virtual machine corresponding to the plurality of scheduling priorities sequentially increase according to a sequence of the scheduling priorities from high to low.

In a second aspect, an embodiment of the present application provides a scheduling method, including:
sequentially scheduling, according to scheduling priorities of a plurality of queues configured for a CPU, execution units in the plurality of queues to run; and
reducing, in a case where an accumulated execution unit running time of any one execution entity reaches a device running time of the execution entity corresponding to a current scheduling priority, a scheduling priority of the execution entity, and adding, to a queue corresponding to the current scheduling priority of the execution entity, at least one execution unit in a startup state in the execution entity; wherein set running times of the execution entity corresponding to the plurality of scheduling priorities sequentially increase according to a sequence of the scheduling priorities from high to low.

In a third aspect, an embodiment of the present application provides a computer system, including a storage component and a processing component, where the processing component includes at least one physical CPU, and the storage component stores one or more computer instructions that are used for being invoked and executed by the processing component, so as to implement the scheduling method as described in the first aspect or the scheduling method as described in the second aspect.

These and other aspects of the present application will be more explicit and lucid in the following description of the embodiments.

### BRIEF DESCRIPTION OF THE DRAWINGS

In order to more clearly explain the technical solutions in the embodiments of the present application or the existing technology, the drawings required for use in describing the embodiments or the existing technology will be briefly introduced below. Apparently, the drawings in the following description are some embodiments of the present application, and a person of ordinary skill in the art can further obtain other drawings according to these drawings without investing creative efforts.

FIG. 1 shows a flow chart of a scheduling method embodiment provided in the present application;

FIG. 2 shows a flow chart of another scheduling method embodiment provided in the present application;

FIG. 3 shows a schematic diagram of scheduling interaction in a practical application in an embodiment of the present application;

FIG. 4 shows a flow chart of a scheduling method in a practical application in an embodiment of the present application;

FIG. 5 shows a schematic structural diagram of a scheduling apparatus embodiment provided in the present application; and

FIG. 6 shows a schematic structural diagram of a computer system embodiment provided in the present application.

### DETAILED DESCRIPTION

In order to enable those skilled in the art to better understand the solutions of the present application, the technical solutions in the embodiments of the present application will be described clearly and completely below with reference to the drawings corresponding to the embodiments of the present application.

In some processes described in the specification and the claims, as well as the above drawings, of the present application, there is contained a plurality of operations that appear in a particular sequence. However, it should be clearly appreciated that these operations cannot be executed in a sequence in which they appear herein, or can be executed in parallel. Serial numbers of the operations, such as 101 and 102, are only used to distinguish different operations, and the serial numbers themselves do not represent any execution sequence. Additionally, these flows can include more or fewer operations, and these operations can be executed in sequence or in parallel. It should be noted that descriptions, such as “first” and “second”, are used herein to distinguish different messages, devices, modules, and the like, which neither represent a sequence, nor define that the “first” and the “second” are different types.

The technical solutions of the embodiments of the present application are applied to a scheduling scenario of a physical Central Processing Unit (CPU), and relate to how an execution unit, such as a virtual CPU, a process, or a thread, is scheduled to run on the physical CPU.

In order to facilitate the understanding of the technical solutions of the present application, technical terms that may be involved in the embodiments of the present application will be interpreted below accordingly:

Virtual Machine refers to a complete computer system that, through software simulation, has complete hardware system functionality and runs in one totally isolated environment.

Virtual CPU (Virtual Central Processing Unit, referred to as VCPU) is a CPU simulated utilizing virtual machine technology, namely a non-physical CPU, and a plurality of virtual CPUs in virtualization technology may share resources of one and the same physical CPU.

Queue is a structure instance corresponding to a physical CPU, which can be understood as a linear table with operations limited, and which is used to organize execution units together that are in a ready state and are sequentially scheduled to run on the physical CPU according to a queue sequence, such as a first-in-first-out sequence.

Scheduler is a kernel module that is used to schedule an execution unit in a queue to run on a physical CPU.

Computing-Intensive Task, in which the computing-intensive means that hard disk and memory of a system have much better performance than CPU, refers to a task that requires a large amount of computation and consumes more CPU resources, and input/output (I/O) operations of the computing-intensive task can be completed in a very short time, while the CPU still has many calculations to process and has a very high load.

I/O-Intensive Task, in which the I/O-intensive means that CPU of a system has much better performance than hard disk and memory, refers to a task that consumes fewer CPU resources and spends most time waiting for I/O operations, and the CPU has a lower load.

Execution Unit herein refers to a unit that is scheduled to run on CPU to execute a specific task, and can refer to a process, a thread, or a virtual CPU. The execution unit corresponds to an execution entity, and one execution entity can include one or more execution units. For example, the execution entity is a virtual machine, and the execution unit can refer to a virtual CPU; and the execution entity is a process, and the execution unit can refer to a thread; and the like. After the virtual CPU is scheduled to a physical CPU to obtain the right to use, a virtual operating system running based on this virtual CPU can schedule a process/thread in the virtual machine to run on the virtual CPU. In addition, a process/thread in a physical environment will also be scheduled to run on the physical CPU.

In related technologies, a plurality of virtual CPUs may preempt resources on one physical CPU at the same time, and the plurality of virtual CPUs will wait to be scheduled to run in a run queue of the physical CPU. If execution of a calculation task corresponding to each virtual CPU has not yet ended after its running for one time slice, it will continue to join the tail of the run queue and continue to wait to be scheduled to run. Usually, in order to ensure fairness, time slices of a physical CPU will be evenly allocated to a plurality of virtual CPUs in a run queue. However, in this way, a virtual machine CPU that executes a task that consumes fewer resources, such as a virtual CPU that executes an I/O-intensive task, may be in a queuing state for a longer time, thereby affecting processing performance.

Taking a virtualization scenario as an example, as described in the Background, there is a case that a plurality of virtual machine CPUs preempt resources of one physical CPU. In order to ensure fairness, in the related technologies, the physical CPU adopts time division multiplexing to divide time of the CPU into a plurality of time slices, and evenly allocate them to waiting virtual CPUs in a queue. However, this manner will affect the real-time execution of tasks that consume fewer resources.

In the process of implementing the present application, the inventors found that tasks that consume more resources demand absolute resources of CPU and do not care about latency. For example, one computing-intensive task that needs 40% of CPU resources does not care so much about whether to get all the CPU resources in the first 400 milliseconds within 1 second, or to wait for 600 millimeters before obtaining 40 milliseconds of the CPU resources. In contrast, tasks that consume fewer resources do not highly require the CPU resources but are very sensitive to latency. For example, if one I/O-intensive task that needs 5% of the CPU resources can complete, in the first 50 milliseconds within 1 second, processing of all requests passed to the CPU for processing, then I/O operations can continue to be efficiently performed; and if the I/O operations start to be processed in the last 50 milliseconds of 1 second, then all the I/O operations are in a stagnant state in the previous 950 milliseconds, causing serious damage to bandwidth and affecting the real-time execution of the task. Since different tasks have different loads, assuming that there is a situation that both a virtual CPU with a computing-intensive task and a virtual CPU with an I/O-intensive task exist competing for resources of a physical CPU at the same time, this often manifests as the virtual CPU with the computing-intensive task being well satisfied, while the performance of the virtual CPU with the I/O-intensive task being seriously damaged. Particularly in a cloud computing scenario, the number of virtual CPUs is much larger than the number of physical CPUs provided by a cloud computing platform, and the resource competition of the physical CPUs is therefore more serious, causing CPUs for I/O-intensive execution to queue and latency, and then affecting the real-time execution of tasks. Based on this founding, the inventors have proposed the technical solutions of the present application through a series of studies, so as to solve the technical problem affecting processing performance in the existing technology, so that on the one hand, the real-time execution of tasks that consume fewer resources is ensured, and on the other hand, it is also ensured that tasks that consume more resources obtain required absolute resources, so as to improve the processing performance of the virtual CPUs.

In the embodiments of the present application, a physical CPU is configured with a plurality of queues respectively corresponding to different scheduling priorities, each virtual machine is respectively set with set running times corresponding to the plurality of scheduling priorities, and the set running times corresponding to the plurality of scheduling priorities sequentially increase according to a sequence of the scheduling priorities from high to low. When a virtual CPU is scheduled to run on the physical CPU, virtual CPUs in the plurality of queues will be sequentially scheduled to run according to the sequence of the scheduling priorities of the plurality of queues from high to low, and in a case where an accumulated virtual CPU running time of any one virtual machine reaches a set running time of the virtual machine corresponding to its currently located scheduling priority, the scheduling priority of the virtual machine is reduced and at least one virtual CPU in a startup state in the virtual machine is added to a queue corresponding to the scheduling priority of the virtual machine. Through the embodiments of the present application, a set running time corresponding to a high scheduling priority is the shortest, a virtual CPU that executes a task that consumes fewer CPU resources mainly runs in a queue corresponding to the high scheduling priority, while a virtual CPU that executes a task that consumes more CPU resources will be downgraded to run in a queue of a low priority, and a queue of a high scheduling priority will be scheduled in priority, so that the virtual CPU that executes the task that consumes fewer CPU resources can promptly interrupt and preempt the virtual CPU in a low scheduling priority, thereby reducing the impact of a high-load virtual machine on a low-load virtual machine, ensuring the real-time task execution of the virtual CPU that executes the task that consumes fewer CPU resources, providing better processing performance for different types of tasks, and ensuring the processing performance of the virtual CPUs.

The technical solutions in the embodiments of the present application will be described clearly and completely below with reference to the drawings in the embodiments of the present application. Apparently, the described embodiments are only some of the embodiments of the present application, rather than all of them. Based on the embodiments in the present application, all other embodiments obtained by those skilled in the art without making creative efforts shall fall within the scope of protection of the present application.

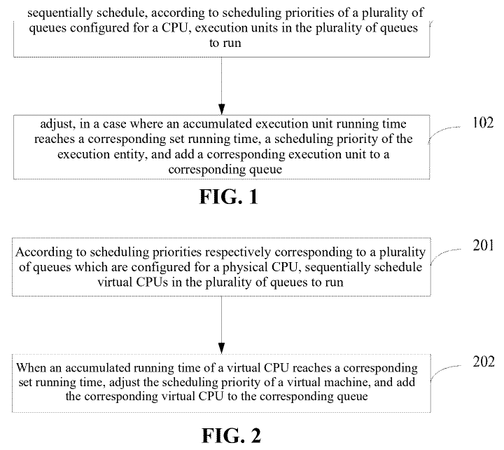

FIG. 1 is a flow chart of a scheduling method embodiment provided in an embodiment of the present application, which can include the following several steps:

101: sequentially scheduling, according to scheduling priorities of a plurality of queues configured for a CPU, execution units in the plurality of queues to run.

In this embodiment, each CPU can be correspondingly configured with a plurality of queues, and the plurality of queues have different scheduling priorities. This CPU can refer to a physical CPU or a virtual CPU, an execution unit can be an actual operation unit of an execution subject, one execution subject can correspond to one or more execution units, and one CPU can correspond to one or more execution subjects. When this CPU is a virtual CPU, the execution unit can be a thread that needs to be scheduled to run on the virtual CPU, and the corresponding execution subject can be a process; when this CPU is a physical CPU, the execution unit can be a virtual CPU, and the corresponding execution subject can be a virtual machine; or the execution unit can be a thread, and the corresponding execution subject is a process.

The execution units that need to consume CPU resources to run also have corresponding scheduling priorities respectively, and a scheduling priority of each execution unit can be a scheduling priority of an execution subject to which it belongs, which means that scheduling priorities of execution units contained in one execution subject are the same. Optionally, an initial scheduling priority of each execution subject can be a highest scheduling priority.

In addition, in order to further ensure the real-time execution of tasks, a scheduling priority of at least one execution subject corresponding to this CPU can be periodically adjusted to the highest scheduling priority, and an execution unit of the at least one execution subject in a startup state is added to a queue corresponding to the highest scheduling priority.

The technical solution of the embodiment of the present application can be executed by a scheduler, which can sequentially schedule the execution units in the plurality of queues to run specifically according to the scheduling priorities, that is, a sequence of the scheduling priorities from high to low.

102: adjusting, in a case where an accumulated execution unit running time of any execution entity reaches a set running time of the execution entity corresponding to a current scheduling priority, a scheduling priority of the execution entity, and adding, to a corresponding queue, at least one execution unit in a startup state in the execution entity.

The execution units are used for executing tasks that consume CPU resources. An execution unit that receives a task will be awakened, thereby switching from a sleep state to a startup state, so as to wait to be scheduled to run on the CPU. After each execution unit receives a task and is awakened, it will be added to a corresponding queue according to its corresponding scheduling priority.

The CPU can divide a plurality of time slices. When each execution unit is scheduled, it runs on the CPU for one time slice. The CPU can evenly divide the plurality of time slices and allocate them to execution units. Running times of execution units in each execution subject on the CPU can be integrated, thereby counting to obtain an accumulated execution unit running time of each execution subject corresponding to the CPU, and the accumulated execution unit running time can refer to a sum of the total running time of the execution units in the execution subject.

According to the sequence of the scheduling priorities from high to low, set running times of each execution entity corresponding to the plurality of scheduling priorities increase sequentially. Optionally, a set running time of each execution entity corresponding to a lowest scheduling priority can be an infinite time, which means that no time limit is performed on the lowest scheduling priority. For other scheduling priorities than the lowest scheduling priority, a set running time can be configured in advance according to a standard of each execution subject. Optionally, a set running time of the execution subject corresponding to a highest scheduling priority can be first determined according to the standard of the execution subject, such as the number of execution units turned on by the same, and then set running times of other scheduling priorities can be determined based on this set running time of the highest scheduling priority. With reference to the standard of the execution subject, a proportion of CPU resources that may be consumed by the execution subject to execute tasks can be determined, and the set running times are configured accordingly, so that a higher scheduling priority corresponds to a smaller set running time.

In this embodiment, in a case where an accumulated execution unit running time of any one execution subject reaches a set running time of this execution subject corresponding to a current scheduling priority, which means that the accumulated execution unit running time is greater than or equal to the set running time, this represents that this set running time cannot meet a CPU running time needed by the execution subject, and it may be executing tasks that consume more resources. At this time, the scheduling priority of the execution subject can be reduced, and at least one execution unit of the execution subject in the startup state can be added to a queue corresponding to the current scheduling priority of the execution subject, so as to reduce a scheduling priority of the execution unit of this execution subject, so as to reduce the impact on execution units that execute tasks that consume fewer resources, ensuring the real-time execution of the tasks; furthermore, execution units that execute tasks that consume more resources are added to a queue of a low scheduling priority that corresponds to a larger set running time, which can also ensure that execution units that will execute tasks that consume more resources can fully obtain resources, thereby improving the processing performance of the virtual CPU.

Optionally, reducing the scheduling priority of the execution subject can be reducing one scheduling priority for the execution subject, so that execution units in the execution subject that execute tasks that consume more resources can be gradually added to a queue of the lowest scheduling priority in a manner of step-by-step reduction.

In a case where an accumulated execution unit running time of each execution subject is less than a set running time of the execution subject corresponding to a current scheduling priority, the current scheduling priority of the execution subject can be kept unchanged, and after an execution unit of the execution subject runs on the CPU for one time slice, it will enter the tail of the queue where it is currently located to continue to wait to be scheduled.

In one practical application, the technical solutions of the embodiments of the present application can be applied to a virtualization scenario, where an execution subject can refer to a virtual machine, an execution unit can be a virtual CPU of the virtual machine, and the virtual CPU is scheduled to run on a physical CPU to execute a corresponding task. In the following one or more embodiments, the technical solutions of the present application are introduced mainly by taking scheduling of a physical CPU as an example. FIG. 2 is a flow chart of another scheduling method embodiment provided in an embodiment of the present application, the technical solution of this embodiment can be executed by a scheduler, and this method can include the following several steps:

201; sequentially scheduling, according to scheduling priorities respectively corresponding to a plurality of queues configured for a physical CPU, virtual CPUs in the plurality of queues to run.

In this embodiment of the present application, one virtual machine can correspond to one or more virtual CPUs, and a plurality of virtual CPUs of one or more virtual machines may be scheduled to run on one physical CPU. After receiving a task, a virtual CPU is awakened, thereby switching from a sleep state to a startup state, so as to wait to be scheduled to run on a corresponding physical CPU.

The physical CPU can be configured with a plurality of queues respectively corresponding to different scheduling priorities. Each virtual CPU that is awakened and waits to be scheduled to run on the physical CPU also corresponds to a scheduling priority, and each virtual CPU can first be added to a corresponding queue according to a respective corresponding scheduling priority, so as to wait to be invoked to run. The scheduling priority of each virtual CPU can be a scheduling priority of a virtual machine to which it belongs, which means that scheduling priorities of execution units in the startup state in virtual CPUs in one virtual machine are the same. Optionally, an initial scheduling priority of each virtual machine can be a highest scheduling priority.

In addition, in order to further ensure the real-time executions of tasks, a scheduling priority of at least one virtual machine corresponding to the physical CPU can be periodically adjusted to a highest priority, and a plurality of virtual CPUs in the startup state in this at least one virtual machine can be added to a queue corresponding to the highest scheduling priority, which means that at a start moment of each scheduling period, scheduling priorities of all virtual CPUs waiting to be scheduled on the physical CPU can be adjusted to the highest priority. In this implementation, the initial scheduling priority of each virtual machine can also be any one scheduling priority.

202: reducing, in a case where an accumulated virtual CPU running time of any one virtual machine reaches a set running time of the virtual machine corresponding to a current scheduling priority, a scheduling priority of the virtual machine, and adding, to a queue corresponding to the current scheduling priority of the virtual machine, at least one virtual CPU in a startup state in the virtual machine; wherein set running times of the virtual machine corresponding to the plurality of scheduling priorities sequentially increase according to a sequence of the scheduling priorities from high to low.

The virtual CPUs are configured to execute tasks. A virtual CPU that receives a task will be awakened to switch to a startup state and added to a corresponding queue to wait to be scheduled to run on the physical CPU. After receiving a task and being awakened, each virtual CPU will be added to a corresponding queue specifically according to its corresponding scheduling priority. Each virtual CPU, after completing execution of the task, will be removed from the queue and enter a sleep state until awakened again.

A plurality of time slices can be divided. When each virtual CPU is scheduled, it runs on the physical CPU for one time slice allocated thereto. The CPU can evenly divide the plurality of time slices and allocate them to virtual CPUs in the queues. A total running time of the virtual CPUs in each virtual machine on the physical CPU can be integrated, thereby obtaining an accumulated virtual CPU running time of each virtual machine on the physical CPU, which means that this accumulated virtual CPU running time refers to a sum of the total running time of the virtual CPUs in the virtual machine. Optionally, in a case where a scheduling priority of at least one virtual machine corresponding to the physical CPU is periodically adjusted, this accumulated virtual CPU running time can specifically refer to an accumulated running time of the virtual machine in a current adjustment period, which means that a sum of the total running time of the virtual CPUs in the virtual machine in the current adjustment period, and the accumulated running time will be re-counted in each adjustment period.

The set running times of each virtual machine corresponding to the plurality of queues sequentially increase according to the sequence of the scheduling priority from high to low. Optionally, a set running time of each virtual machine corresponding to a lowest scheduling priority can be an infinite time, which means that no time limit is performed on the lowest scheduling priority. For other scheduling priorities than the lowest scheduling priority, a set running time can be configured in advance according to a standard of each virtual machine. The standard of the virtual machine defines basic attributes of the virtual machine in terms of computing performance, storage performance, network performance, and the like, which, for example, can include the number of virtual CPUs, a memory size, and the like.

Optionally, a set running time of the virtual machine corresponding to a highest scheduling priority can be first determined according to the standard of the virtual machine, and then set running times of other scheduling priorities can be determined based on this set running time of the highest scheduling priority. For example, the set running times of other scheduling priorities can be set to be twice, or the like, of a previous one scheduling priority. Certainly, this is not specifically limited in the present application, and can be set in conjunction with an actual condition. A higher scheduling priority corresponds to a smaller set running time.

In this embodiment, when an accumulated virtual CPU running time of the virtual machine reaches a set running time of its currently located scheduling priority, this represents that this set running time cannot meet a CPU time needed by the virtual machine, and it may be executing tasks that consume more resources. At this time, the scheduling priority of the virtual machine can be reduced, and at least one virtual CPU in this virtual machine that is in the startup state and is used to execute a task can be added to a queue corresponding to the current scheduling priority of the virtual machine, so as to reduce a scheduling priority of the virtual CPU of this virtual machine, reducing the impact on virtual CPUs in the virtual machine that execute tasks that consume fewer resources, and ensuring the real-time execution of the tasks; furthermore, virtual CPUs that execute tasks that consume more resources are added to a queue of a low scheduling priority that corresponds to a larger set running time, which can also ensure that virtual CPUs that will execute tasks that consume more resources can obtain sufficient CPU resources.

Optionally, reducing the scheduling priority of the virtual machine can be reducing one scheduling priority for the virtual machine, so that virtual CPUs in the virtual machine that execute tasks that consume more resources can gradually added to a queue of the lowest scheduling priority in a manner of step-by-step reduction, so as to ensure effective execution of the tasks. Therefore, in some embodiments, reducing the scheduling priority of the virtual machine and adding the at least one virtual CPU in the startup state to the corresponding queue can include:
reducing one scheduling priority for this virtual machine; and
adding, to the queue corresponding to the current scheduling priority of this virtual machine, at least one virtual CPU of this virtual machine in a startup state.

In a case where an accumulated virtual CPU running time of any one virtual machine is less than a set running time of this virtual machine corresponding to a current scheduling priority, the current scheduling priority of the virtual machine can be kept unchanged, and after a virtual CPU of the virtual machine runs on the physical CPU for one time slice, it will enter the tail of the queue where it is current to continue to wait to be scheduled.

In the embodiment of the present application, by dynamically adjusting scheduling priorities of virtual CPUs according to CPU times consumed by the virtual CPUs, it is ensured that a virtual CPU that consumes more resources, such as a computing-intensive one, is in a lower scheduling priority to consume the remaining CPU resources, while a virtual CPU that consumes fewer resources, such as an I/O-intensive one, is in a highest scheduling priority and can promptly interrupt and preempt virtual CPUs of low scheduling priorities to improve the real-time execution of tasks, which, on the one hand, ensures the response time of, for example, I/O-intensive virtual CPUs, while also trying to use the remaining CPU resources to serve more computing-intensive virtual machine CPUs.

In some embodiments, reducing, in the case where the accumulated virtual CPU running time of the any one virtual machine reaches the set running time of the virtual machine corresponding to the current scheduling priority, the scheduling priority of the virtual machine, and adding, to the queue corresponding to the current scheduling priority of the virtual machine, the at least one virtual CPU in the startup state in the virtual machine, can include:
judging, in a case where any one virtual CPU of any one virtual machine ends running for a current time slice or any one virtual CPU is awakened, whether the accumulated virtual CPU running time of the virtual machine reaches the set running time of the virtual machine corresponding to the current scheduling priority;
reducing, if the accumulated virtual CPU running time of the virtual machine reaches the set running time of the virtual machine corresponding to the current scheduling priority, the scheduling priority of the virtual machine, and adding, to the corresponding queue, at least one virtual CPU in a startup state in the virtual machine; and
keeping, if the accumulated virtual CPU running time of the virtual machine does not reach the set running time of the virtual machine corresponding to the current scheduling priority the scheduling priority of the virtual machine unchanged.

After the any one virtual CPU ends running for the current time slice, it needs to rejoin the queue to continue to wait to be scheduled, and in the case where the any one virtual CPU receives a task and is awakened, it also needs to join the queue to wait to be scheduled. Therefore, in the case where the any one virtual CPU ends running for the current time slice or the any one virtual CPU is awakened, the accumulated virtual CPU running time of the virtual machine can be determined to make a decision of whether the scheduling priority of the virtual machine needs to be adjusted, or the like.

An accumulated virtual CPU running time of each virtual machine can be counted and recorded after any one virtual CPU corresponding thereto ends running for one time slice. Certainly, counting can also be performed after any one virtual CPU corresponding thereto is awakened. Therefore, in some embodiments, in the case where the any one virtual CPU of the any one virtual machine ends running for the current time slice or the any one virtual CPU is awakened to start up, the accumulated virtual CPU running time of the virtual machine can be counted, and then it can be judged whether the accumulated virtual CPU running time reaches the corresponding set running time.

The at least one virtual CPU in the startup state in the virtual machine can include a virtual CPU that has been added to any queue, and a virtual CPU that has been awakened but has not yet been added to any queue.

In the case where the accumulated virtual CPU running time is less than the set running time of the virtual machine corresponding to the current scheduling priority, the scheduling priority of the virtual machine can be kept unchanged.

In some embodiments, reducing, in the case where the accumulated virtual CPU running time of the any one virtual machine reaches the set running time of the virtual machine corresponding to the current scheduling priority, the scheduling priority of the virtual machine, and adding, to the corresponding queue, the at least one virtual CPU in the startup state, can include:
reducing, in a case where any one virtual machine is in a non-lowest scheduling priority and if the accumulated virtual CPU running time of the virtual machine reaches the set running time of the virtual machine corresponding to the current scheduling priority, the scheduling priority of the virtual machine, and adding, to the corresponding queue, the at least one virtual CPU in the startup state.

However, if any one virtual machine is in a lowest scheduling priority, a scheduling priority of the virtual machine can be directly kept unchanged.

In addition, as can be known from the above description, a scheduling priority of at least one virtual machine corresponding to the physical CPU can be periodically adjusted to a highest priority, and a plurality of virtual CPUs in the startup state in this at least one virtual machine can be added to a queue corresponding to the highest scheduling priority. In some embodiments, reducing, in the case where the accumulated virtual CPU running time of the any one virtual machine reaches the set running time of the virtual machine corresponding to the current scheduling priority, the scheduling priority of the virtual machine, and adding, to the corresponding queue, the at least one virtual CPU in the startup state, can include:
reducing, in a case where the accumulated virtual CPU running time of the any one virtual machine reaches the set running time of the virtual machine corresponding to the current scheduling priority and a current adjustment period has not ended, the scheduling priority of the virtual machine, and adding, to the corresponding queue, the at least one virtual CPU in the startup state.

If any one virtual machine is in a lowest scheduling priority, then a scheduling priority of the virtual machine will be kept unchanged until a current adjustment period ends.

In some embodiments, if task execution of any one virtual CPU ends, then it can be dequeued from a queue where it is located, and the virtual CPU can be deleted from the queue where it is located. This dequeued virtual CPU enters a sleep state until it receives a task again and is awakened to switch to a startup state.

In some embodiments, since both a virtual CPU that is awakened and a virtual CPU for which a current time slice has ended running but task execution has not ended will be added to a corresponding queue, so that an enqueue event occurs, in order to further ensure the real-time execution of tasks, the method can further include:
scheduling, for an enqueue event of any one queue, a currently enqueued virtual CPU to preemptively run on the physical CPU when a scheduling priority of the currently enqueued virtual CPU is higher than a scheduling priority of a currently running virtual CPU.

In addition, a preempted virtual CPU can also be inserted into a first position of a corresponding queue according to a current scheduling priority thereof.

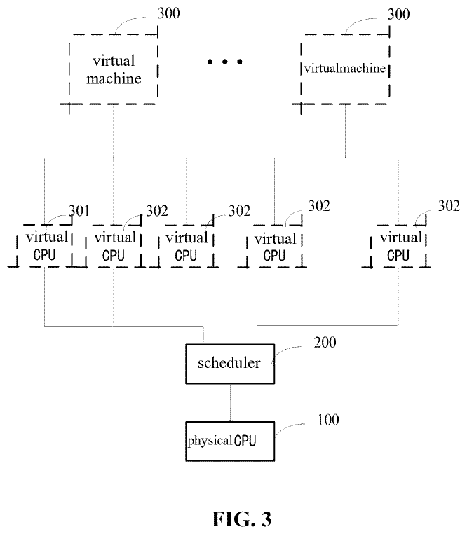

In order to facilitate understanding, the technical solutions of the present application will be introduced below with reference to the interaction schematic diagram shown in FIG. 3. As depicted in FIG. 3, a computer system can include a plurality of physical CPUs 100. Taking one physical CPU as an example, assuming that one physical CPU 100 can support a plurality of virtual machines 300, and the plurality of virtual machines 300 store a plurality of virtual CPUs 301 to preempt resources of a physical CPU 302 to run on the physical CPU 302 to execute tasks.

A scheduler 200 loads and maintains 3 queues for the physical CPU 302: Queue 1, Queue 2, and Queue 3, sequentially corresponding to High, Normal, and Low scheduling priorities, where the High scheduling priority is a highest scheduling priority, the Low scheduling priority is a lowest scheduling priority, and the Normal scheduling priority is an intermediate scheduling priority.

Each virtual machine 300 can be pre-configured to allocate set running times corresponding to these three scheduling priorities, which, optionally, can configure a set running time Htime corresponding to the High scheduling priority and a set running time Ntime corresponding to the Normal scheduling priority. Since the Low scheduling priority is the lowest scheduling priority, a set running time corresponding thereto can be null, indicating infinity.

An initial scheduling priority of each virtual machine can be the High scheduling priority, and a scheduling priority of each virtual machine can be periodically adjusted to be the High scheduling priority.

A virtual CPU 301 in each virtual machine 300 will be added to a corresponding queue according to a scheduling priority of the virtual machine 300.

The scheduler 200 can sequentially traverse the three queues according to a sequence of the scheduling priorities from high to low, so as to schedule a virtual CPU to run on the physical CPU for one time slice.

The scheduler 200 can count an accumulated virtual CPU running time of each virtual machine in a current adjustment period, and judge, in a case where any one virtual CPU of the virtual machine ends running for a current time slice or any one virtual CPU is awakened, whether the accumulated virtual CPU running time of the virtual machine reaches a set running time of the virtual machine corresponding to a current scheduling priority, so as to reduce, if so, one scheduling priority for the virtual machine and add, to a queue of a lower scheduling priority, a virtual CPU thereof that is in a awakened state; and keep, if not, the current scheduling priority unchanged and add, to a queue corresponding to the current scheduling priority, the virtual CPU for which the current time slice ends running or the CPU that is awakened.

For example, when one virtual CPU of the virtual machine in the High scheduling priority ends running for a current time slice or is awakened, an accumulated virtual CPU running time of the virtual machine in a current adjustment period is counted, and the Htime of this virtual machine corresponding to the High scheduling priority is determined. If the accumulated virtual CPU running time is greater than or equal to the Htime and the current adjustment period has not ended, then the scheduling priority of the virtual machine will be reduced to the Normal scheduling priority, and all virtual CPUs of this virtual machine that are in a startup state enter a queue of the Normal scheduling priority to wait to be scheduled; and if the accumulated virtual CPU running time is less than the Htime, then the High scheduling priority will be kept unchanged, and virtual CPUs that end running for the current time slice or are awakened will continue to enter the queue of the High scheduling priority to wait to be scheduled.

When one virtual CPU of the virtual machine in the Normal scheduling priority ends running for a current time slice or is awakened, an accumulated virtual CPU running time of the virtual machine in a current adjustment period is counted, and the Ntime of this virtual machine corresponding to the Normal scheduling priority is determined. If the accumulated virtual CPU running time is greater than or equal to the Ntime and the current adjustment period has not ended, then the scheduling priority of the virtual machine will be reduced to the Low scheduling priority, and all virtual CPUs of this virtual machine that are in a startup state enter a queue of the Low scheduling priority to wait to be scheduled; and if the accumulated virtual CPU running time is less than the Ntime, then the Normal scheduling priority will be kept unchanged, and virtual CPUs that end running for the current time slice or are awakened will continue to enter the queue of the Normal scheduling priority to wait to be scheduled.

If there is a reduction to the Low scheduling priority for one virtual machine, then the Low scheduling priority will be kept unchanged until a current adjustment period ends. A virtual CPU in this virtual machine enters the queue of the Low scheduling priority after ending running for each time slice or being awakened.

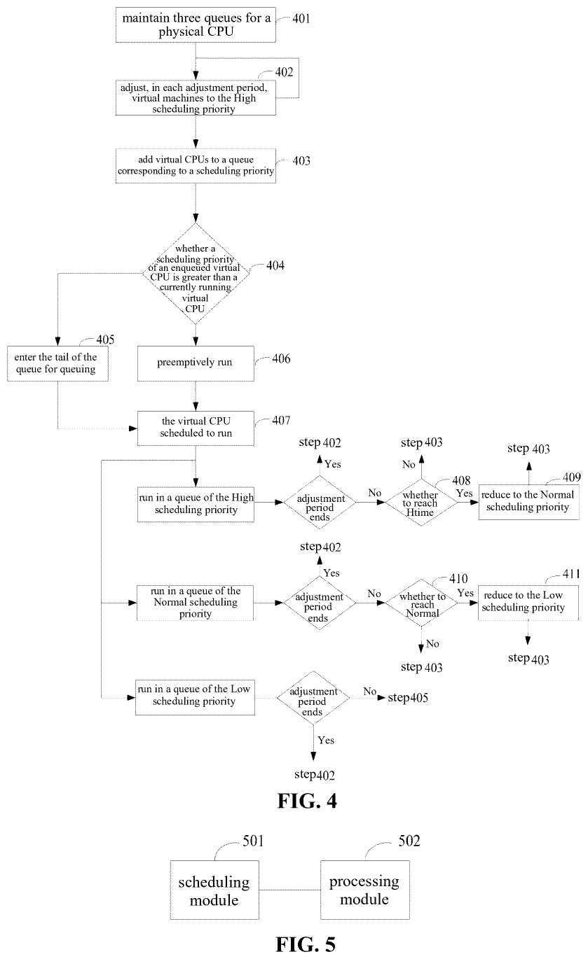

Taking the above three scheduling priorities as an example, a detailed scheduling flow shown in FIG. 4 can include:
loading, by a scheduler, and maintaining three queues for a physical CPU sequentially corresponding to High, Normal, and Low scheduling priorities 401;
adjusting, in each adjustment period, virtual machines to the High scheduling priority 402;
causing virtual CPUs to enter a corresponding queue according to a scheduling priority of a virtual machine corresponding thereto 403;
detecting whether a scheduling priority of a currently enqueued virtual CPU is greater than a currently running virtual CPU 404; queuing, if not, at the tail of the queue 405, and preemptively running if so 406;
scheduling the virtual CPU to run 407;
causing the virtual CPU to run in a queue of the High scheduling priority, and judging, when the adjustment period has not ended and after a current time slice ends running, whether an accumulated virtual CPU running time of the virtual machine corresponding thereto reaches Htime 408, and if yes, executing step 403; and if not, executing step 403 after adjusting the scheduling priority to the Normal scheduling priority 409.
causing the virtual CPU to run in a queue of the Normal scheduling priority, and judging, when the adjustment period has not ended and after a current time slice ends running, whether an accumulated virtual CPU running time of the virtual machine corresponding thereto reaches Ntime 410, and if yes, executing step 403; and if not, executing step 403 after adjusting the scheduling priority to the Low scheduling priority 411.
causing the virtual CPU to run in a queue of the Low scheduling priority, and executing step 403 when the adjustment period has not ended and after a current time slice ends running.

If the adjustment period ends, then the scheduling priority of the virtual machine will be adjusted to the High scheduling priority.

In this embodiment, the High priority ensures the real-time execution of tasks of virtual machines that have a certain demand for CPU latency and consume fewer resources, and the Normal priority is used for virtual machines that do not require high real-time performance and relatively consume resources; and the Low priority is used to limit virtual machines with excessive resource consumption, and reduce the impact of these high-load virtual machines on low-load virtual machines. Each virtual machine can define different Htimes and Ntimes according to standard. A scheduling priority is dynamically adjusted by an accumulated virtual CPU running time consumed by virtual CPUs of a virtual machine, and a task type of the virtual machine is intelligently identified, which can ensure that better processing performance can be provided for different types of tasks.

It should be noted that a specific scheduling flow is explained above by taking only three scheduling priorities as an example. It can be understood that in practical applications, a plurality of scheduling priorities can be set, which is not specifically limited in the present application.

FIG. 5 is a schematic structural diagram of a scheduling apparatus embodiment provided in an embodiment of the present application, which can include:
a scheduling module 501 for sequentially scheduling, according to scheduling priorities of a plurality of queues configured for a CPU, execution units in the plurality of queues to run; and
a processing module 502 for reducing, in a case where an accumulated running time of any one execution entity reaches a device running time of the execution entity corresponding to a current scheduling priority, a scheduling priority of the execution entity, and adding, to a corresponding queue, at least one execution unit in a startup state in the execution entity; wherein set running times of the execution entity corresponding to the plurality of scheduling priorities sequentially increase according to a sequence of the scheduling priorities from high to low

In a practical application, the scheduling module can be specifically used for sequentially scheduling, according to scheduling priorities respectively corresponding to a plurality of queues configured for a physical CPU, virtual CPUs in the plurality of queues to run;

The processing module can be specifically used for reducing, in a case where an accumulated virtual CPU running time of any one virtual machine reaches a set running time of the virtual machine corresponding to a current scheduling priority, the scheduling priority of the virtual machine, and adding, to a corresponding queue, at least one virtual CPU in a startup state; wherein set running times of the virtual machine corresponding to the plurality of scheduling priorities sequentially increase according to a sequence of the scheduling priorities from high to low.

In some embodiments, this processing module can specifically judge, in a case where any one virtual CPU of any one virtual machine ends running for a current time slice or any one virtual CPU is awakened, whether an accumulated virtual CPU running time of the virtual machine reaches a set running time of the virtual machine corresponding to a current scheduling priority; reduce, if so, the scheduling priority of the virtual machine, and add, to a corresponding queue, at least one virtual CPU in a startup state; and keep, if not, the scheduling priority of the virtual machine unchanged.

In some embodiments, the processing module reducing the scheduling priority of the virtual machine, and adding the at least one virtual CPU in the startup state to the corresponding queue includes: reducing one scheduling priority for the virtual machine; and adding, to a queue corresponding to a current scheduling priority, at least one virtual CPU of the virtual machine that is in a startup state.

In some embodiments, this processing module is further used for keeping, in a case where an accumulated virtual CPU running time is less than a set running time corresponding to a current scheduling priority of the virtual machine, the current scheduling priority of the virtual machine unchanged.

In some embodiments, the processing module is further used for periodically adjusting a scheduling priority of at least one virtual machine corresponding to the physical CPU to be a highest scheduling priority, and adding, to a queue corresponding to the highest scheduling priority, a plurality of virtual CPUs in a startup state in the at least one virtual machine.

In some embodiments, this scheduling module can specifically reduce, in a case where an accumulated virtual CPU running time of any one virtual machine reaches a set running time of the virtual machine corresponding to a current scheduling priority and a current adjustment period has not ended, the scheduling priority of the virtual machine, and add, to a corresponding queue, at least one virtual CPU in a startup state.

In some embodiments, this scheduling module is further used for scheduling, for an enqueue event of any one queue, a currently enqueued virtual CPU to preemptively run on the physical CPU when a scheduling priority of the currently enqueued virtual CPU is higher than a scheduling priority of a currently running virtual CPU; and inserting a preempted virtual CPU into a first position of a corresponding queue according to a current scheduling priority thereof.

In some embodiments, this scheduling module can be specifically used for reducing, in a case where any one virtual machine is not in a lowest scheduling priority and in a case where an accumulated virtual CPU running time of the virtual machine reaches a set running time of the virtual machine corresponding to a current scheduling priority, the scheduling priority of the virtual machine, and adding, to a corresponding queue, at least one virtual CPU in a startup state.

In some embodiments, this processing module is further used for keeping, if any one virtual machine is in a lowest scheduling priority, a scheduling priority of the virtual machine unchanged until a current adjustment period ends.

The scheduling apparatus shown in FIG. 5 can execute the scheduling method described in the embodiment shown in FIG. 1 or FIG. 2, the implementation principle and technical effect of which will not be repeated. The specific manners in which each module or unit executes operations in the scheduling apparatus in the above embodiment have been described in detail in the embodiments concerning the methods, and will not be elaborated here.

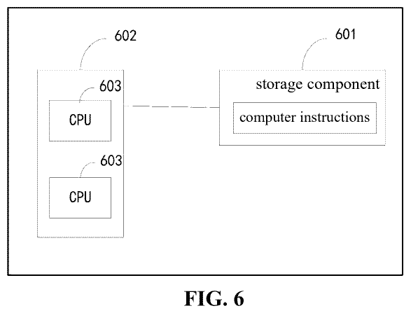

In addition, an embodiment of the present application further provides a computer system. As described in FIG. 6, this computer system can include a storage component 601 and a processing component 602; and this processing component 602 can include at least one physical CPU 603.

The storage component 601 stores one or more computer instructions that are used for being invoked and executed by the processing component 602 to implement the scheduling method of the embodiment shown in FIG. 1 or FIG. 2.

This computer system can be a physical device, or can be implemented as a distributed cluster consisting of a plurality of physical devices;

This computer system can be an elastic computing host provided by a cloud computing platform to provide an elastic computing service (ECS), and a virtual machine created in this computer system can be an ECS instance.

The storage component 601 is configured to store various types of data to support operations at a terminal. The storage component can be implemented by any type or combination of volatile or non-volatile storage devices, such as static random-access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

Certainly, the computer system can further include other components, such as an input/output interface, a communication component, or the like. The input/output interface provides an interface between the processing component and a peripheral interface module, and the above peripheral interface module can be an output device, an input device, or the like. The communication component is configured to facilitate wired or wireless communication between the computing device and other devices.

An embodiment of the present application further provides a computer-readable storage medium stored with a computer program that, when executed by a computer, can implement the scheduling method of the embodiment shown above in FIG. 1 or FIG. 2. This computer-readable medium can be contained in the computer system described in the above embodiment, or can also exist alone without being assembled into this electronic device.

An embodiment of the present application further provides a computer program product including a computer program carried on a computer-readable storage medium, wherein the computer program, when executed by a computer, can implement the scheduling method of the embodiment shown in FIG. 1 or FIG. 2. In such an embodiment, the computer program can be downloaded and installed from a network, and/or installed from a removable medium. When this computer program is executed by a processor, various functions defined in the system of the present application are executed.

Those skilled in the art can clearly appreciate that, for convenience and conciseness of description, for a specific working process of the system, apparatus, and unit described above, reference can be made to a corresponding process in the foregoing method embodiments, which will not be repeated here.

The apparatus embodiments described above are merely exemplary, in which the unit explained as a separate component can or cannot be physically detached, and the component shown as a unit can or cannot be a physical unit, that is, can be located in one place, or can also be distributed over a plurality of network units. Some or all of the modules can be selected according to practical needs to meet the purposes of the solutions of the embodiments. Those of ordinary skill in the art can have an understanding and conduct an implementation without investing creative efforts.

Through the above description of the implementations, those skilled in the art can clearly understand that the implementations can be implemented by means of software plus a necessary general-purpose hardware platform, and certainly, can also be implemented by hardware. Based on this understanding, the above technical solutions essentially or the part that contributes to the existing technology can be embodied in the form of a software product, and this computer software product can be stored in a computer-readable storage medium, such as ROM/RAM, magnetic disk, optical disk, or the like, and includes several instructions to enable a computer device (which can be a personal computer, a server, or a network device, or the like) to execute the methods described in the embodiments or some parts of the embodiments.

Finally, it should be noted that the above embodiments are only used to explain the technical solutions of the present application, rather than limiting them. Although the present application has been explained in detail with reference to the foregoing embodiments, those of ordinary skill in the art should understand that the technical solutions recorded in the foregoing embodiments can still be modified, or some technical features thereof can be equivalently replaced; and these modifications or replacements do not make the essence of the corresponding technical solutions depart from the spirit and scope of the technical solutions of the embodiments of the present application.

1. A scheduling method, comprising:
sequentially scheduling, according to scheduling priorities respectively corresponding to a plurality of queues configured for a physical CPU, virtual CPUs in the plurality of queues to run;
reducing, in a case where an accumulated virtual CPU running time of any one virtual machine reaches a set running time of the virtual machine corresponding to a current scheduling priority, a scheduling priority of the virtual machine, and adding, to a queue corresponding to the current scheduling priority of the virtual machine, at least one virtual CPU in a startup state in the virtual machine; wherein set running times of the virtual machine corresponding to the plurality of scheduling priorities sequentially increase according to a sequence of the scheduling priorities from high to low.

2. The method according to claim 1, wherein reducing, in the case where the accumulated virtual CPU running time of the any one virtual machine reaches the set running time of the virtual machine corresponding to the current scheduling priority, the scheduling priority of the virtual machine, and adding, to the queue corresponding to the current scheduling priority of the virtual machine, the at least one virtual CPU in the startup state in the virtual machine, comprise:
judging, in a case where any one virtual CPU of any one virtual machine ends running for a current time slice or any one virtual CPU is awakened to start up, whether the accumulated virtual CPU running time of the virtual machine reaches the set running time of the virtual machine corresponding to the current scheduling priority;
reducing, in response to determining that the accumulated virtual CPU running time of the virtual machine reaches the set running time of the virtual machine corresponding to the current scheduling priority, the scheduling priority of the virtual machine, and adding, to the queue corresponding to the current scheduling priority of the virtual machine, at least one virtual CPU in the startup state in the virtual machine;
keeping, in response to determining that the accumulated virtual CPU running time of the virtual machine does not reach the set running time of the virtual machine corresponding to the current scheduling priority, the scheduling priority of the virtual machine unchanged.

3. The method according to claim 2, wherein reducing the scheduling priority of the virtual machine, and adding the at least one virtual CPU in the startup state to the corresponding queue, comprise:
reducing one scheduling priority for the virtual machine; and
adding, to the queue corresponding to the current scheduling priority of the virtual machine, at least one virtual CPU in the startup state in the virtual machine.

4. The method according to claim 1, further comprising:
periodically adjusting a scheduling priority of at least one virtual machine corresponding to the physical CPU to be a highest scheduling priority, and adding, to a queue corresponding to the highest scheduling priority, a plurality of virtual CPUs in the startup state in the at least one virtual machine.

5. The method according to claim 4, wherein reducing, in the case where the accumulated virtual CPU running time of the any one virtual machine reaches the set running time of the virtual machine corresponding to the current scheduling priority, the scheduling priority of the virtual machine, and adding, to the queue corresponding to the current scheduling priority of the virtual machine, the at least one virtual CPU in the startup state in the virtual machine, comprise:
reducing, in a case where the accumulated virtual CPU running time of the any one virtual machine reaches the set running time of the virtual machine corresponding to the current scheduling priority and a current adjustment period has not ended, the scheduling priority of the virtual machine, and adding, to the queue corresponding to the current scheduling priority of the virtual machine, the at least one virtual CPU in the startup state in the virtual machine.

6. The method according to claim 1, further comprising:
scheduling, for an enqueue event of any one queue, a currently enqueued virtual CPU to preemptively run on the physical CPU in a case where a scheduling priority of the currently enqueued virtual CPU is higher than a scheduling priority of a currently running virtual CPU; and
inserting a preempted virtual CPU into a first position of a corresponding queue according to a current scheduling priority of the preempted virtual CPU.

7. The method according to claim 1, wherein reducing, in the case where the accumulated virtual CPU running time of the any one virtual machine reaches the set running time of the virtual machine corresponding to the current scheduling priority, the scheduling priority of the virtual machine, and adding, to the queue corresponding to the current scheduling priority of the virtual machine, the at least one virtual CPU in the startup state in the virtual machine, comprise:
reducing, in a case where any one virtual machine is not in a lowest scheduling priority and in response to determining that the accumulated virtual CPU running time of the virtual machine reaches the set running time of the virtual machine corresponding to the current scheduling priority, the scheduling priority of the virtual machine, and adding, to the queue corresponding to the current scheduling priority of the virtual machine, the at least one virtual CPU in the startup state in the virtual machine.

8. The method according to claim 4, further comprising:
keeping, in response to determining that any one virtual machine is in a lowest scheduling priority, the scheduling priority of the virtual machine unchanged until a current adjustment period ends.

9. A scheduling method, comprising:
sequentially scheduling, according to scheduling priorities of a plurality of queues configured for a CPU, execution units in the plurality of queues to run; and
reducing, in a case where an accumulated execution unit running time of any one execution entity reaches a device running time of the execution entity corresponding to a current scheduling priority, a scheduling priority of the execution entity, and adding, to a queue corresponding to the current scheduling priority of the execution entity, at least one execution unit in a startup state in the execution entity; wherein set running times of the execution entity corresponding to the plurality of scheduling priorities sequentially increase according to a sequence of the scheduling priorities from high to low.

10. A computer system, comprising a storage component, and a processing component; wherein the processing component comprises at least one physical CPU; and
the storage component stores one or more computer instructions that are used for being invoked and executed by the processing component, to:
sequentially schedule, according to scheduling priorities respectively corresponding to a plurality of queues configured for a physical CPU, virtual CPUs in the plurality of queues to run;
reduce, in a case where an accumulated virtual CPU running time of any one virtual machine reaches a set running time of the virtual machine corresponding to a current scheduling priority, a scheduling priority of the virtual machine, and adding, to a queue corresponding to the current scheduling priority of the virtual machine, at least one virtual CPU in a startup state in the virtual machine; wherein set running times of the virtual machine corresponding to the plurality of scheduling priorities sequentially increase according to a sequence of the scheduling priorities from high to low.

11. The computer system according to claim 10, wherein reducing, in the case where the accumulated virtual CPU running time of the any one virtual machine reaches the set running time of the virtual machine corresponding to the current scheduling priority, the scheduling priority of the virtual machine, and adding, to the queue corresponding to the current scheduling priority of the virtual machine, the at least one virtual CPU in the startup state in the virtual machine, comprise:
judging, in a case where any one virtual CPU of any one virtual machine ends running for a current time slice or any one virtual CPU is awakened to start up, whether the accumulated virtual CPU running time of the virtual machine reaches the set running time of the virtual machine corresponding to the current scheduling priority;
reducing, in response to determining that the accumulated virtual CPU running time of the virtual machine reaches the set running time of the virtual machine corresponding to the current scheduling priority, the scheduling priority of the virtual machine, and adding, to the queue corresponding to the current scheduling priority of the virtual machine, at least one virtual CPU in the startup state in the virtual machine;
keeping, in response to determining that the accumulated virtual CPU running time of the virtual machine does not reach the set running time of the virtual machine corresponding to the current scheduling priority, the scheduling priority of the virtual machine unchanged.

12. The computer system according to claim 11, wherein reducing the scheduling priority of the virtual machine, and adding the at least one virtual CPU in the startup state to the corresponding queue, comprise:
reducing one scheduling priority for the virtual machine; and
adding, to the queue corresponding to the current scheduling priority of the virtual machine, at least one virtual CPU in the startup state in the virtual machine.

13. The computer system according to claim 10, wherein the storage component stores one or more computer instructions that are used for being invoked and executed by the processing component, to periodically adjust a scheduling priority of at least one virtual machine corresponding to the physical CPU to be a highest scheduling priority, and adding, to a queue corresponding to the highest scheduling priority, a plurality of virtual CPUs in the startup state in the at least one virtual machine.

14. The computer system according to claim 13, wherein reducing, in the case where the accumulated virtual CPU running time of the any one virtual machine reaches the set running time of the virtual machine corresponding to the current scheduling priority, the scheduling priority of the virtual machine, and adding, to the queue corresponding to the current scheduling priority of the virtual machine, the at least one virtual CPU in the startup state in the virtual machine, comprise:
reducing, in a case where the accumulated virtual CPU running time of the any one virtual machine reaches the set running time of the virtual machine corresponding to the current scheduling priority and a current adjustment period has not ended, the scheduling priority of the virtual machine, and adding, to the queue corresponding to the current scheduling priority of the virtual machine, the at least one virtual CPU in the startup state in the virtual machine.

15. The computer system according to claim 10, wherein the storage component stores one or more computer instructions that are used for being invoked and executed by the processing component, to:
schedule, for an enqueue event of any one queue, a currently enqueued virtual CPU to preemptively run on the physical CPU in a case where a scheduling priority of the currently enqueued virtual CPU is higher than a scheduling priority of a currently running virtual CPU; and
insert a preempted virtual CPU into a first position of a corresponding queue according to a current scheduling priority of the preempted virtual CPU.

16. The computer system according to claim 10, wherein reducing, in the case where the accumulated virtual CPU running time of the any one virtual machine reaches the set running time of the virtual machine corresponding to the current scheduling priority, the scheduling priority of the virtual machine, and adding, to the queue corresponding to the current scheduling priority of the virtual machine, the at least one virtual CPU in the startup state in the virtual machine, comprise:
reducing, in a case where any one virtual machine is not in a lowest scheduling priority and in response to determining that the accumulated virtual CPU running time of the virtual machine reaches the set running time of the virtual machine corresponding to the current scheduling priority, the scheduling priority of the virtual machine, and adding, to the queue corresponding to the current scheduling priority of the virtual machine, the at least one virtual CPU in the startup state in the virtual machine.

17. The computer system according to claim 13, wherein the storage component stores one or more computer instructions that are used for being invoked and executed by the processing component, to keep, in response to determining that any one virtual machine is in a lowest scheduling priority, the scheduling priority of the virtual machine unchanged until a current adjustment period ends.

18. A computer system, comprising a storage component, and a processing component; wherein the processing component comprises at least one physical CPU; and
the storage component stores one or more computer instructions that are used for being invoked and executed by the processing component, to implement the scheduling method in claim 9.
